(19) United States
(12) Patent Application Publication
(10) Pub. No.: US 2024/0119261 A1
(43) Pub. Date: Apr. 11, 2024

(54) DISCRETE TOKEN PROCESSING USING DIFFUSION MODELS

(71) Applicant: DeepMind Technologies Limited, London (GB)

(72) Inventors: Robin Strudel, Paris (FR); Rémi Leblond, Cachan (FR); Laurent Sifre, Paris (FR); Sander Etienne Lea Dieleman, London (GB); Nikolay Savinov, London (GB); Will S. Grathwohl, Brooklyn, NY (US); Corentin Tallec, Paris (FR); Florent Altché, Paris (FR); Iaroslav Ganin, Montreal (CA); Arthur Mensch, Paris (FR); Yilin Du, Cambridge, MA (US)

(21) Appl. No.: 18/374,447

(22) Filed: Sep. 28, 2023

Related U.S. Application Data
(60) Provisional application No. 63/411,045, filed on Sep. 28, 2022.

(51) Int. Cl. G06N 3/045

(52) U.S. Cl. CPC G06N 3/045

(57) ABSTRACT

Methods, systems, and apparatus, including computer programs encoded on computer storage media, for generating an output sequence of discrete tokens using a diffusion model. In one aspect, a method includes generating, by using the diffusion model, a final latent representation of the sequence of discrete tokens that includes a determined value for each of a plurality of latent variables; applying a de-embedding matrix to the final latent representation of the output sequence of discrete tokens to generate a de-embedded final latent representation that includes, for each of the plurality of latent variables, a respective numeric score for each discrete token in a vocabulary of multiple discrete tokens; selecting, for each of the plurality of latent variables, a discrete token from among the multiple discrete tokens in the vocabulary that has a highest numeric score; and generating the output sequence of discrete tokens that includes the selected discrete tokens.

### CROSS-REFERENCE TO RELATED APPLICATION

This application claims priority to U.S. Provisional Application No. 63/411,045, filed on Sep. 28, 2022. The disclosure of the prior application is considered part of and is incorporated by reference in the disclosure of this application.

### BACKGROUND

This specification relates to processing data using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

According to a first aspect, there is provided a computer-implemented method for generating an output sequence of discrete tokens using a diffusion model. The method comprises generating, by using the diffusion model, a final latent representation of the sequence of discrete tokens that includes a determined value for each of a plurality of latent variables. Generating the final latent representation comprises, at each of multiple reverse diffusion time steps: processing a diffusion model input comprising an intermediate latent representation of the sequence of discrete tokens for the reverse diffusion time step to generate an estimate of the sequence of discrete tokens as of the reverse diffusion time step; using the estimate to define a distribution over a continuous space of possible values for each of the plurality of latent variables; and generating an updated intermediate latent representation of the sequence of discrete tokens for the reverse diffusion time step through sampling from the distributions. The method further comprises applying a de-embedding matrix having learned values to the final latent representation of the output sequence of discrete tokens to generate a de-embedded final latent representation that includes, for each of the plurality of latent variables, a respective numeric score for each discrete token in a vocabulary of multiple discrete tokens. The method further comprises selecting, for each of the plurality of latent variables, a discrete token from among the multiple discrete tokens in the vocabulary that has a highest numeric score; and generating the output sequence of discrete tokens that includes the selected discrete tokens.

For a first reverse diffusion time step, the intermediate latent representation may be an initial latent representation. For subsequent reverse diffusion time steps, the intermediate latent representation may be the updated intermediate latent representation that has been generated in the immediately preceding reverse diffusion time step.

In implementations, the estimate of the sequence of discrete tokens as of the reverse diffusion time step is an estimate of the final latent representation of the output sequence of discrete tokens as of the reverse diffusion time step.

In implementations, the discrete tokens comprise text, symbols, or signals.

In implementations, the diffusion model input further comprises an estimate of the sequence of discrete tokens generated as of a previous reverse diffusion time step. In implementations, the estimate of the sequence of discrete tokens as of the previous reverse diffusion time step is an estimate of the final latent representation of the output sequence of discrete tokens as of the previous reverse diffusion time step.

In implementations, generating the output sequence of discrete tokens using the diffusion model comprises generating unconditional discrete tokens.

In implementations, generating the output sequence of discrete tokens using the diffusion model comprises generating discrete tokens conditioned on an input sequence of discrete tokens, and wherein the method comprises:
receiving the input sequence of discrete tokens;
converting each discrete token in the input sequence into a one-hot vector; and
applying an embedding matrix having pre-trained values to each one-hot vector to embed the one-hot vector into a continuous vector.

In implementations, generating the output sequence of discrete tokens using the diffusion model comprises generating discrete tokens conditioned on an input sequence of discrete tokens, and wherein the method comprises:
receiving the input sequence of discrete tokens;
converting each discrete token in the input sequence into a one-hot vector; and
applying an embedding matrix to each one-hot vector to embed the one-hot vector into an embedding.

In implementations, the output sequence of discrete tokens also includes the input sequence of discrete tokens received by the diffusion model.

In implementations, the input sequence of discrete tokens comprises discrete tokens representing an audio data input including spoken words e.g. characterizing a waveform of the audio in the time domain or in the time-frequency domain.

In implementations, the output tokens represent audio data including spoken words e.g. characterizing a waveform of the audio in the time domain or in the time-frequency domain.

In implementations, the input sequence is generated from an audio signal comprising a spoken utterance. In implementations, an input may be received in the form of an audio (speech) signal, which is converted by a speech-to-text converter to form the input sequence.

In implementations, the output sequence of discrete tokens represent text. In implementations, the output sequence of discrete tokens is converted by a text-to-speech converter to form an audio signal.

In implementations the input sequence of discrete tokens represents a sequence of actions to be performed by an agent e.g. a mechanical agent in a real-world environment implementing the actions to perform a mechanical task.

In implementations, the output sequence of discrete tokens represents a sequence of actions to be performed by an agent e.g. a mechanical agent in a real-world environment implementing the actions to perform a mechanical task.

In implementations, the method further comprises:
applying a linear projection to the continuous vector to generate a projected continuous vector; and
processing the projected continuous vector using the diffusion model.

In implementations, generating the discrete tokens conditioned on the input sequence of discrete tokens comprises using a classifier-free guidance technique.

In implementations, the de-embedding matrix has been learned during training of the diffusion model while the embedding matrix is fixed during the training of the diffusion model.

In implementations, the method further comprises training the diffusion model on unlabeled discrete token data comprising discrete token inputs to minimize a mean-squared error between each discrete token input and an estimate of the discrete token input generated by the diffusion model as of a sampled reverse diffusion time step.

In implementations, the training also minimizes a cross-entropy loss evaluated with respect to the final latent representation of the sequence of discrete tokens generated by the diffusion model from the discrete token input.

In implementations, the training comprises:
applying binary masks to a sequence of discrete token inputs, the binary masks comprising one or more first masks defining conditioning tokens in the sequence and one or more second masks defining infilling tokens in the sequence; and
training the diffusion model on the masked sequence of discrete token inputs to generate an estimate of the sequence of discrete token inputs that includes the infilling tokens in the sequence.

In implementations, the training comprises learning values of the de-embedding matrix while keeping the pre-trained values of the embedding matrix fixed.

According to another aspect, there is provided a system comprising one or more computers and one or more storage devices storing instructions that are operable, when executed by the one or more computers, to cause the one or more computers to perform the operations of any of the above methods.

According to another aspect, there is provided a computer storage medium encoded with instructions that, when executed by one or more computers, cause the one or more computers to perform the operations of any of the above methods.

This specification describes a system implemented as computer programs on one or more computers in one or more locations that generates an output sequence of discrete tokens using a diffusion model which performs a reverse diffusion process on continuous embeddings in an embedding space.

In some cases, the generation process can be unconditional where the output sequence may be generated by the diffusion model from random noise. In other cases, the generation process can be conditional where, for example, an output text, computer program code, symbol, or signal sequence generated by the diffusion model is a completion or expansion of an input text, computer program code, symbol, or signal sequence.

Particular embodiments of the subject matter described in this specification can be implemented so as to realize one or more of the following advantages.

The diffusion model as described in this specification is a model that performs a diffusion process in continuous latent space, and yet is capable of processing data such as textual data that is inherently discrete, i.e., receiving discrete input data and/or generating discrete output data. By performing the diffusion process on continuous embeddings in the latent space and then converting the final latent representation back to discrete space with a continuous-to-discrete step that uses a learnable de-embedding matrix, the described diffusion model is both flexible, e.g., is easily configurable for both conditional and unconditional discrete data generation, and scalable, e.g., can be scaled up to an arbitrary large model having 100 million, 500 million, or more parameters, and can thus better suit the needs of various generative tasks. The described diffusion model achieves or even exceeds the state-of-the-art performance on a wide range of conditional and unconditional text generation tasks attained by many existing autoregressive models.

Advantageously, unlike most existing autoregressive models which predict output tokens one after another in a way that early tokens are not informed by later ones, the described diffusion models can predict all tokens in a sequence at once. This allows for bidirectional (e.g., rather than causal) attention; so the token selections that are made later in a sequence can influence the earlier ones for higher quality data generation. This also makes the inference process significantly more parallelizable, i.e., makes it possible to generate an arbitrary amount of data within a fixed time budget by performing multiple diffusion processes in parallel with each other, as the generation of all tokens can happen concurrently with the diffusion model rather than sequentially as required by autoregressive models.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example data generation system.

FIG. 2 is a flow diagram of an example process for generating a discrete output sequence.

FIG. 3 is a flow diagram of an example process of sub-steps of one of the steps of the process of FIG. 2.

Like reference numbers and designations in the various drawings indicate like elements.

### DETAILED DESCRIPTION

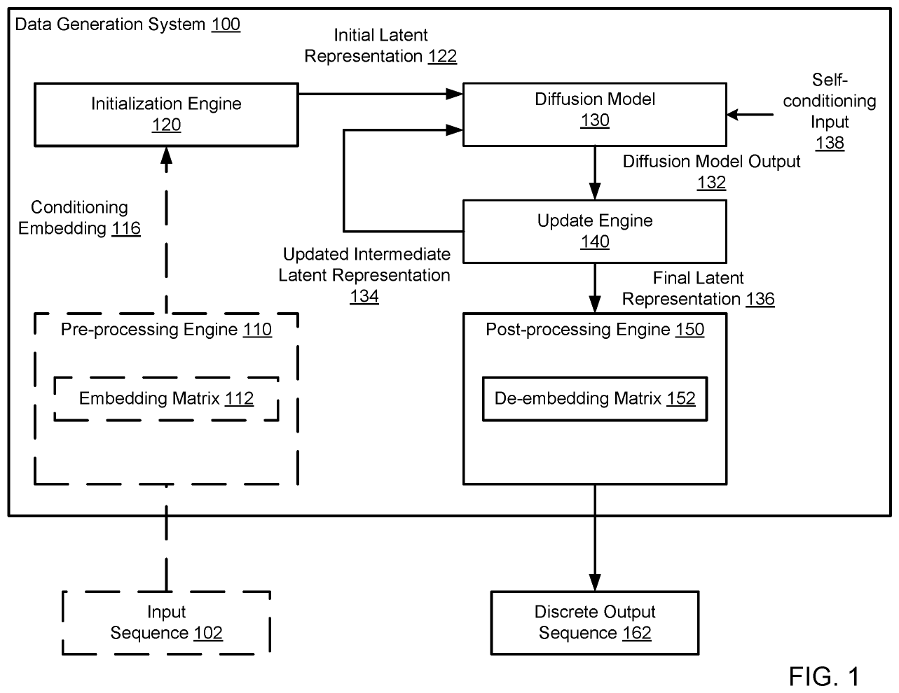

FIG. 1 is a diagram of an example data generation system 100. The data generation system 100 is an example of a system implemented as computer programs on one or more computers in one or more locations, in which the systems, components, and techniques described below can be implemented.

The data generation system 100 is a system that generates a discrete output sequence 162 in response to received requests. The data generation system 100 can store the discrete output sequence 162 in an output data repository or provide the discrete output sequence 162 for use for some other immediate purpose. For example, the data generation system 100 can then output the discrete output sequence 162 for presentation, e.g., on a client device that submitted the data generation request.

The discrete output sequence 162 includes a plurality of discrete tokens. Each discrete token can be an individual, discrete data item. In this specification, continuous data refers to data that may take on any value within a specified range, constrained only by the precision of the numerical format used by a computer system. In contrast, discrete data have additional constraints that further limit the possible values that the data may take on within the specified range beyond those possible values in the numerical format used by the computer system.

In one example, the discrete output sequence includes a plurality of tokens from a finite number of possible tokens.

For example, the discrete output sequence 162 can include a respective token from a vocabulary of discrete tokens at each of multiple positions. The vocabulary of tokens can include any of a variety of discrete tokens that represent text, symbols, or signals. For example, the vocabulary of discrete tokens can include one or more of characters, sub-words, words, punctuation marks, numbers, or other symbols that appear in a corpus of text. The text can, for example, be natural language text or computer program code. In some examples, the output tokens represent audio data including spoken words e.g. characterizing a waveform of the audio in the time domain or in the time-frequency domain. In some examples, the output sequence of discrete tokens represent text. In one example, the output sequence of discrete tokens is converted by a text-to-speech converter to form an audio signal. In some examples, the output sequence of discrete tokens represents a sequence of actions to be performed by an agent e.g. a mechanical agent in a real-world environment implementing the actions to perform a mechanical task.

In some cases, the data generation system 100 can be configured as an unconditional output sequence generation system that generates discrete output sequences 162 unconditioned, i.e., without conditioning on any conditioning input. In these implementations, the discrete output sequences 162 generated by the system 100 approximate samples of a distribution of training input sequences that were used during the training of the system 100.

In other cases, the data generation system 100 can be configured as a conditional output sequence generation system that generates discrete output sequences 162 conditioned on an input sequence 102. In some of these cases, the input sequence 102 includes a discrete input sequence. Like the discrete output sequence 162, the discrete input sequence can include a respective token from a vocabulary of tokens at each of multiple positions. The vocabulary of tokens can include any of a variety of discrete tokens that represent text, symbols, or signals. In others of these cases, the input sequence 102 includes a continuous input sequence, e.g., that represents a sequence of pixels of an image, or that represent a waveform of audio or a spectrogram of an audio.

When configured as a conditional output sequence generation system, for example, the data generation system 100 can receive an input sequence 102 that includes text data, additional data other than text, e.g., embeddings of data of a different data type, e.g., an image, video, speech, etc., or both, and to generate a discrete output sequence 162 that is a sequence of text, e.g., a completion of the input sequence 102, an expansion of the input sequence 102, a response to a question posed in the input sequence 102, a sequence of text that is about a topic specified by the input sequence 102, a text description of the data of the different data type, and so on.

As another example, the data generation system 100 can receive an input sequence 102 that includes one or more code segments and to generate a discrete output sequence 162 that includes code segments conditioned on the input sequence 102, e.g., one or more code segments that, when combined with the code segments included in the input sequence 102, constitutes an executable application, program, object, or sequence of instructions.

In both cases, it will be appreciated that text (both natural language text and computer program code), symbols, and signals are understood as merely examples discrete data for illustration, and the discrete tokens can be discrete data items in many other formats or modalities. For example, the discrete output sequence 162 can be or include a sequence of biological data (e.g., a sequence of gene expressions), a sequence of electronic health record data (e.g., a sequence of health events), a sequence of clinical procedure data (e.g., a sequence of physician orders, clinical documentation, notes, diagnosis codes, medications, etc.), and so on.

In one example, an input may be received in the form of an audio (speech) signal, captured by a microphone, which is converted by a speech-to-text converter to form the input sequence 102. In some examples, the input sequence of discrete tokens comprises tokens representing an audio data input including spoken words e.g. characterizing a waveform of the audio in the time domain or in the time-frequency domain. In some examples the input sequence of discrete tokens represents a sequence of actions to be performed by an agent e.g. a mechanical agent in a real-world environment implementing the actions to perform a mechanical task.

To generate the discrete output sequence 162, the data generation system 100 uses an initialization engine 120 to initialize the latent representation, i.e., to generate an initial latent representation 122, of the discrete output sequence 162, and then uses a diffusion model neural network 130 (or “diffusion model 130” for short) and an update engine 140 to generate a final latent representation 136 of the discrete output sequence 162, based on performing a reverse diffusion process to update the initial latent representation 122 over multiple reverse diffusion time steps. The final latent representation 136 is therefore generated in the last reverse diffusion time step of the reverse diffusion process.

The initial latent representation 122 has the same dimensionality as the final latent representation 136 but has different values. That is, the initial latent representation 122 includes multiple latent variables and the final latent representation 136 includes the same number of latent variables, but the values for these latent variables will generally differ between these two representations 122 and 136.

When configured as an unconditional output sequence generation system, the initialization engine 120 generates the initial latent representation 122 by sampling an initial value for each of the multiple latent variables included in the initial latent representation 122 from a corresponding noise distribution, e.g., a Gaussian distribution or another predetermined distribution. The initial latent representation 122 therefore includes the multiple latent variables, with the initial value for each latent variable being sampled from a corresponding noise distribution.

When configured as a conditional output sequence generation system, a pre-processing engine 110, which is an optional component of the data generation system 100, processes the received input sequence 102 to generate a conditioning embedding 116 that includes a sequence of numerical values. The initialization engine 120 then generates the initial latent representation 122 based on using the numerical values included in the conditioning embedding 116 as the initial values for some of the latent variables included in the initial latent representation 122, and on sampling an initial value for each of the remaining latent variables from a corresponding noise distribution, e.g., a Gaussian distribution or another predetermined distribution. The initial latent representation 122 therefore includes multiple latent variables, with the initial value for each of some latent variables being determined from the input sequence 102, and the initial value for each of other latent variables being sampled from a corresponding noise distribution.

More specifically, the pre-processing engine 110 includes an embedding matrix 112 that defines a mapping from a discrete space to an embedding space. To define this mapping, the embedding matrix 112 can be a matrix that has the dimension of D×V, i.e., can have D×V pre-defined values included as entries of the matrix, where D is the embedding size (the size of each continuous vector in the embedding space) and V is the vocabulary size (the total number of discrete tokens included in the vocabulary of tokens). Thus in one example, each token ω in the vocabulary has an associated embedding e_{ω}ϵ [symbol] ^{D}, with fixed norm \sqrt{D} to match the norm of a random Gaussian sample in dimension D used to noise clean data. The embedding values may be generated during a pre-training phase. In one example, the embedding matrix is a matrix of all of the embeddings for the vocabulary. An embedding of an entity (e.g., a word) can refer to a representation of the entity as an ordered collection of numerical values, e.g., a vector of numerical values. An embedding of an entity can be generated, e.g., as the output of a neural network that processes data characterizing the entity, or as a result of some other encoding process.

The pre-processing engine 110 converts each token included in the input sequence 102 into a discrete one-hot vector, and applies the embedding matrix 112 to each discrete one-hot vector, e.g., based on elementwise multiplication operations, to map the discrete one-hot vector into a continuous vector in the embedding space having the numerical values for the token. Therefore, in some implementations, the conditioning embedding 116 is made up of the numerical values included in the continuous vectors that have been generated as a result of applying the embedding matrix 112 to the input sequence 102. In other implementations, the pre-processing engine 110 additionally applies a linear projection to each continuous vector to generate a projected continuous vector, and then generates the conditioning embedding 116 from the numerical values included in the projected continuous vectors. The conversion to tokens may be performed using a SentencePiece tokenizer, as described in Kudo et. al., “Sentencepiece: A simple and language independent subword tokenizer and detokenizer for neural text processing”, In EMNLP (Demonstration), pp. 66-71, Association for Computational Linguistics, 2018, the entire contents of which are incorporated by reference herein, composed of 32000 words.

The diffusion model 130 can have any appropriate architecture that allows the diffusion model to, at any given reverse diffusion time step, process a diffusion model input for the reverse diffusion time step that includes an intermediate latent representation (as of the reverse diffusion time step) that has the same dimensionality as the discrete output sequence 162 to generate a diffusion model output 132 for the given reverse diffusion time step. The diffusion model output 132 includes an estimate of the discrete output sequence 162 (as of the reverse diffusion time step) that also has the same dimensionality as the discrete output sequence 162.

For example, the diffusion model 130 can be a convolutional neural network, e.g., a U-Net or other architecture, that includes one or more convolutional residual blocks. As another example, the diffusion model 130 can be an attention neural network that includes one or more attention blocks, e.g., self-attention blocks, gated attention blocks, or cross-attention blocks. As yet another example, the diffusion model 130 can include both convolutional residual blocks and attention blocks.

At the given reverse diffusion time step, the data generation system 100 then uses an update engine 140 to update the intermediate latent representation based on the estimate of the discrete output sequence 162 for the given reverse diffusion time step. The intermediate latent representation after being updated by the update engine 140 in the given reverse diffusion time step will be referred to in this specification as the updated intermediate latent representation 134; the intermediate latent representation after being updated in the last reverse diffusion time step in the reverse diffusion process will be referred to in this specification as the final intermediate latent representation 136.

Thus, at any given reverse diffusion time step, the intermediate latent representation, which is provided as (a part of) the diffusion model input to the diffusion model 130, will be the updated intermediate latent representation 134 that has been generated in the immediately preceding reverse diffusion time step. For the very first reverse diffusion time step, the intermediate latent representation is the initial latent representation 122 that is generated by the initialization engine 120.

More specifically, at any given reverse diffusion time step, the update engine 140 uses at least the estimate of the discrete output sequence 162 for the given reverse diffusion time step to define, for each of the multiple latent variables included in the initial latent representation 122, a corresponding distribution over a continuous space of possible values. The update engine 140 then generates an updated intermediate latent representation 134 of the discrete output sequence 162 for the reverse diffusion time step by selecting a value for each latent variable from the corresponding distribution, e.g., by selecting the value with the highest probability or by sampling from the distributions. The updated latent representation 134 therefore includes the multiple latent variables, with the value for each latent variable being sampled from a corresponding distribution that is defined by the diffusion model output 132 of the diffusion model 130.

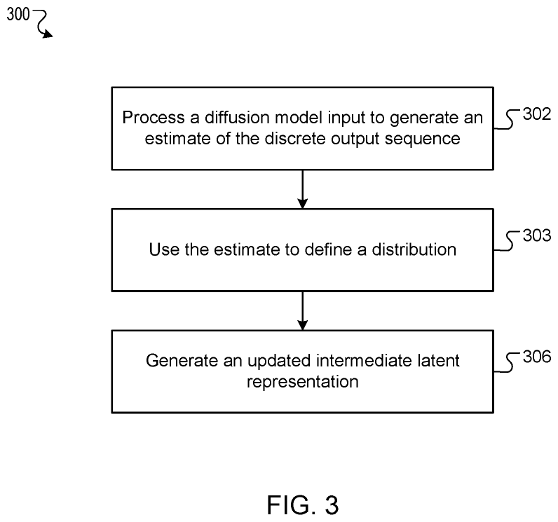

To define such a distribution for each latent variable, the update engine 140 can compute a mean, and, optionally, a variance, of the distribution based on the estimate of the discrete output sequence 162 and on the intermediate latent representation before being updated in the given reverse diffusion time step. The update step will be described further below with reference to FIG. 3.

Some implementations of the data generation system 100 make use of a self-conditioning input 138 when performing the reverse diffusion process. When the data generation system 100 is configured as a conditional output sequence generation system, the use of self-conditioning can improve the quality of the discrete output sequence 162.

At any given reverse diffusion time step, the self-conditioning input 138 can be the estimate of the discrete output sequence 162 included in the diffusion model output generated at the immediately preceding reverse diffusion time step. Thus, for any given reverse diffusion time step, the diffusion model 130 can process a diffusion model input that includes (i) the intermediate latent representation (as of the reverse diffusion time step) and (ii) the estimate of the discrete output sequence 162 generated at the immediately preceding reverse diffusion time step, to generate the diffusion model output 132 for the given reverse diffusion time step.

Some implementations of the data generation system 100 make use of a guidance when performing the reverse diffusion process. That is, the reverse diffusion process is sometimes a guided reverse diffusion process. To alleviate the need for a separately trained guidance neural network, the guidance can be a classifier-free guidance.

Using classifier-free guidance can involve processing, by the diffusion model 130, at any given reverse diffusion time step, a sequence of conditioning tokens as a part of a diffusion model input to generate the diffusion model output. Conditioning tokens can be defined by a binary conditioning mask set to ones for positions (“conditioning positions”) in the discrete output sequence each having a predetermined discrete token, and zero for positions (“infilling positions”) in the discrete output sequence each having an unknown discrete token, i.e., the positions for which the discrete tokens need to be generated by the system.

After the last reverse diffusion time step, the data generation system 100 provides the final latent representation 136 that is in the same embedding space as the initial latent representation 122 to a post-processing engine 150. The final latent representation 136 includes multiple latent variables. Each latent variable has a determined value that is determined as a result of the reverse diffusion process and that may be different from its initial value. The post-processing engine 150 processes the final latent representation 136 to generate the discrete output sequence 162 that is in the same discrete space as the input sequence 102.

To that end, the post-processing engine 150 includes a de-embedding matrix 152 that defines a mapping from the embedding space to the discrete space. To define this mapping, the de-embedding matrix 152 can be a matrix that has the dimension of V×D, i.e., can have V×D learned values included as entries of the matrix, where V is the vocabulary size (the total number of discrete tokens included in the vocabulary of tokens) and D is the embedding size (the size of each continuous vector in the embedding space).

The post-processing engine 150 applies the de-embedding matrix 152 to each latent variable included in the final latent representation 136, e.g., based on elementwise multiplication operations, to generate a de-embedded final latent representation. The de-embedded final latent representation includes, for each latent variable included in the final latent representation 136, a distribution over the vocabulary of tokens that corresponds to the latent variable. For each latent variable, the corresponding distribution includes a respective numeric score for each token included in the vocabulary.

The post-processing engine 150 then generates the discrete output sequence 162 by selecting, for each latent variable, a token from the vocabulary in accordance with the corresponding distribution, e.g., by selecting the token with the highest numeric score or by sampling from the corresponding distribution.

Because the computations involved in the generation of each discrete output sequence is parallelizable over the entire length of the discrete output sequence, the data generation system 100 makes better usage of the computing resources of hardware accelerators on which the generation system 100 can be implemented.

Hardware accelerators are computing devices having specialized hardware configured to perform specialized computations, including, e.g., parallel computations. Examples of accelerators include graphics processing units (“GPUs”), field-programmable gate arrays (“FGPAs”), and application-specific integrated circuits (“ASICs”), including tensor processing units (“TPUs”).

Training the diffusion model 130 and other trainable components of the data generation system 100 to determine the trained parameter values of these components will be described further below.

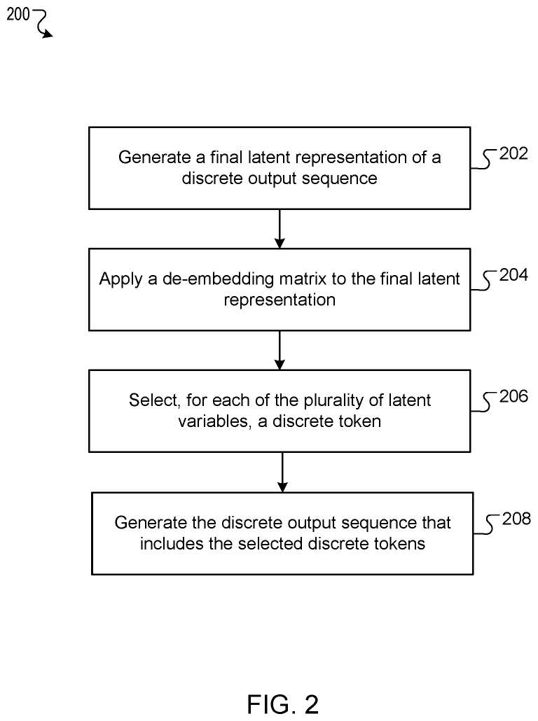

FIG. 2 is a flow diagram of an example process 200 for generating a discrete output sequence. For convenience, the process 200 will be described as being performed by a system of one or more computers located in one or more locations. For example, a data generation system, e.g., the data generation system 100 depicted in FIG. 1, appropriately programmed in accordance with this specification, can perform the process 200.

The system performs a reverse diffusion process on an initial latent representation of a discrete output sequence to generate a final latent representation of the discrete output sequence (step 202). The discrete output sequence includes a respective token from a vocabulary of tokens at each of multiple positions. The vocabulary of tokens can include any of a variety of discrete tokens that represent text, symbols, or signals.

The initial latent representation has the same dimensionality as the final latent representation but has different values. That is, the initial latent representation includes multiple latent variables and the final latent representation includes the same number of latent variables, but the initial values for these latent variables included in the initial latent representation and the determined values for these latent variables included in the final latent representation will generally differ from each other.

When configured as an unconditional output sequence generation system, the system can generate the initial latent representation based on sampling an initial value for each of the multiple latent variables from a corresponding noise distribution (e.g., a Gaussian distribution or another predetermined distribution).

When configured as a conditional output sequence generation system, the system can receive a input sequence and then map the received input sequence into a conditioning embedding that includes a sequence of numerical values. The mapping can be performed by applying an embedding matrix E∈ [symbol] ^{D×V}, where D is the embedding size and V is the vocabulary size, to a one-hot vector corresponding to each token included in the input sequence. The system can therefore generate the initial latent representation based on using the numerical values included in the conditioning embedding as the initial values for some of the latent variables included in the initial latent representation, and on sampling an initial value for each of the remaining latent variables from a corresponding noise distribution.

The system then generates the final latent representation by using a diffusion model to update the initial latent representation over multiple reverse diffusion time steps. In other words, the final latent representation is the updated intermediate latent representation generated in the last reverse diffusion time step.

Updating the initial latent representation is explained in more detail below with reference to FIG. 3, which shows a flow diagram of an example process 300 of sub-steps 302-306 of step 202. In general, the system can repeatedly perform process 300 at each of multiple reverse diffusion time steps T, T−1, . . . , 2, 1.

The system processes a diffusion model input for the reverse diffusion time step to generate a diffusion model output (step 302). The diffusion model output can include an estimate of the discrete output sequence as of the reverse diffusion time step. The diffusion model input, on the other hand, can include (i) an intermediate latent representation of the discrete output sequence (as of the reverse diffusion time step) xₜ, and (ii) a time index t indicating the current reverse diffusion time step. In one example, the diffusion model is a trained neural network, which takes as input an intermediate latent representation of the discrete output sequence (as of the reverse diffusion time step) xₜ, and a time index t indicating the current reverse diffusion time step and outputs an estimate of the final latent representation of the of the discrete output sequence as of the reverse diffusion time step \hat{x}₀.

For the very first reverse diffusion time step, the intermediate latent representation xₜ is the initial latent representation. For any subsequent reverse diffusion time step, the intermediate latent representation xₜ is the updated intermediate latent representation that has been generated in the immediately preceding reverse diffusion time step.

For example, the estimate of the discrete output sequence x̅₀ can thus be defined as:

x̅₀^{t}=\hat{x}₀(xₜ,t,θ),

where θ represents the parameters of the diffusion model.

Optionally, the diffusion model input also includes a self-conditioning input. At any given reverse diffusion time step, the self-conditioning input can be the estimate of the discrete output sequence included in the diffusion model output generated at the immediately preceding reverse diffusion time step. Thus, for any given reverse diffusion time step, the diffusion model input can additionally include the estimate of the discrete output sequence \tilde{x}₀^{t+1} included in the diffusion model output generated at the immediately preceding reverse diffusion time step t+1.

As another example, the estimate of the discrete output sequence \tilde{x}₀ can thus be alternatively defined as:

\tilde{x}₀^{t}=\hat{x}₀(xₜ,t,θ),

where θ similarly represents the parameters of the diffusion model.

Further optionally, the diffusion model input also includes a guidance, e.g., a classifier-free guidance. When classifier-free guidance is used, for any given reverse diffusion time step, the diffusion model input can additionally include a fixed sequence of conditioning tokens.

As yet another example, the estimate of the discrete output sequence \tilde{x}_{0,s} can thus be alternatively defined as:

\tilde{x}_{0,x}^{t}=\hat{x}₀(xₜ,0,0,t,θ)+s·(\hat{x}₀(xₜ,c,\tilde{x}₀^{t+1},t,θ)−\hat{x}₀(x_{t,}0,0,t,θ)),

where s≥1 is the guidance scale, and c represents the conditioning tokens used in the classifier-free guidance. Conditioning tokens c can be defined by a binary conditioning mask set to ones for positions ( ) in the discrete output sequence each having a predetermined discrete token, and zero for positions in the discrete output sequence each having an unknown discrete token, i.e., the positions for which the discrete tokens need to be generated by the system.

The system uses the estimate of the discrete output sequence \hat{x}₀ to define a distribution over a continuous space of possible values for each of the plurality of latent variables (step 304). To define such a distribution for each latent variable, the system can compute a mean, and, optionally, a variance, of the distribution based on (i) the estimate of the discrete output sequence \hat{x}₀ and (ii) the intermediate latent representation xₜ included in the diffusion model input.

For example, the system can compute the mean μ of the distribution as:

$${μ}_{θ} ( {x}_{t} , t ) = \frac{\sqrt{{\overline{α}}_{t - 1}} {β}_{t}}{1 - {\overline{α}}_{t}} {\hat{x}}_{0} ( {x}_{t} , t , θ ) + \frac{\sqrt{{α}_{t}} ( 1 - {\overline{α}}_{t - 1} )}{1 - {\overline{α}}_{t}} {x}_{i} ,$$

and a variance of the distribution as:

$${σ ( t )}^{2} = \frac{1 - {\overline{α}}_{t - 1}}{1 - {\overline{α}}_{t}} {β}_{t} ,$$

where αₜ:=1−βₜ,α̅ₜ:=Πₛ₌₁^{t}αₛ, and βₜ defines the variance for the current reverse diffusion time step according to a predetermined variance schedule β₁, β₂, . . . , β_{T-1}, β_{T}. In one example, the system uses a fixed schedule, where the values of βₜ are pre-determined and fixed.

The system generates an updated intermediate latent representation of the discrete output sequence xₜ₋₁ for the reverse diffusion time step from the distributions (step 306). The system can do this by selecting a value for each latent variable from the corresponding distribution, e.g., by sampling a value from the continuous space of possible values in accordance with the distribution:

xₜ₋₁˜p₀(⋅|xₜ)= [symbol] (μ_{θ}(xₜ,t),σ(t)²I),

where I is an identity matrix.)

The updated latent representation xₜ₋₁ therefore includes the multiple latent variables, with the value for each latent variable being sampled from a corresponding distribution that is defined by the diffusion model output of the diffusion model for the current reverse diffusion time step.

Returning to FIG. 2, the system applies a de-embedding matrix to the final latent representation of the discrete output sequence x₀ to generate a de-embedded final latent representation (step 204). The de-embedded final latent representation includes, for each latent variable, a distribution over the vocabulary of tokens that corresponds to the latent variable. For each latent variable, the corresponding distribution includes a respective numeric score for each token in the vocabulary of tokens.

For example, the system can generate the de-embedded final latent representation by computing:

p_{R}(ω|x₀)=Πₖ₌₁^{N}Cat(ωₖ| [symbol] (x₀)ₖ),

where R∈ [symbol] ^{V×D} is the de-embedding matrix with vocabulary size V and embedding size D, ω is a one-hot representation of a token in the vocabulary, and Cat(ωₖ|l) represents the softmax probability of a token k in the vocabulary of tokens with logits l∈ [symbol] ^{V}.

The system selects, for each of the multiple latent variables, a token from among the tokens in the vocabulary in accordance with the corresponding distribution (step 206). For each latent variable, the system can for example select the token that has the highest numeric score from among all of the tokens in the vocabulary.

The system generates the discrete output sequence (step 208). The discrete output sequence includes the tokens that have been selected from the vocabulary at step 206. When configured as a conditional output sequence generation system, the discrete output sequence can optionally also include the input sequence that was received as input by the system.

By repeatedly performing the process 200, the system can generate different discrete output sequences. That is, the process 200 can be performed as part of predicting a discrete output sequence from an input sequence for which the desired output, i.e., the discrete output sequence that should be generated by the system from the input sequence, is not known.

Some steps of the process 200, e.g., the sub-step 302 of the step 202, can also be performed as part of processing input sequences derived from a set of training data, i.e., inputs derived from a set of inputs for which the discrete output sequences that should be generated by the system is known, in order to train the trainable components of the system to determine trained values for the parameters of these components. In one example, the diffusion model may be trained on the C4 dataset as described in Raffel et al., “Exploring the limits of transfer learning with a unified text-to-text transformer”, J. Mach. Learn. Res., 21:140:1-140:67, 2020, the entire contents of which are incorporated by reference herein. In one example, the training data may be converted to tokens using a SentencePiece tokenizer, as described in Kudo et. al., “Sentencepiece: A simple and language independent subword tokenizer and detokenizer for neural text processing”, In EMNLP (Demonstration), pp. 66-71, Association for Computational Linguistics, 2018, the entire contents of which are incorporated by reference herein, composed of 32000 words. In one example, the diffusion model may be trained with a sequence length of 256. In one example, 10% of padding tokens may be inserted uniformly (i.e. not necessarily at the end of the sequence) in the training set to allow the model to generate samples of varying size and provide more flexibility.

Specifically, the system can repeatedly perform the sub-step 302 of the step 202 on input sequences selected from a set of unlabeled discrete training data as part of a diffusion model training process to train the trainable components of the system to optimize an objective function that is appropriate for the discrete data generation task that the diffusion model is configured to perform.

For example, the objective function can include a diffusion loss term that trains the diffusion model θ on input sequences x₀ selected from unlabeled discrete training data to minimize a mean-squared error between each input sequence x₀ and an estimate of the input sequence \hat{x}₀ generated by the diffusion model as of a sampled reverse diffusion time step within the reverse diffusion process:

[symbol]

_{diffusion}= [symbol] _{(1,T)}∥x₀−\hat{x}₀(xₜ,t,θ)∥²,

The objective function can additionally include a reconstruction loss term that trains the de-embedding matrix R to minimize a cross-entropy loss evaluated with respect to the final latent representation of the discrete output sequence generated by the diffusion model from the input sequence:

[symbol]

_{recon}= [symbol] ₓ_{₀}_{˜q}_{_{V}}_{(ω)}[−log [symbol] (ω|x₀)],

where q_{V}(x₀|ω)= [symbol] (Eω,σ₀²I), where σ₀ is a constant scale factor with a similar order of magnitude as β₁.

During training, the system can incorporate any number of techniques to improve the speed, the effectiveness, or both of the training process.

For example, the system can use a span masking technique to train the diffusion model on a number of infilling tasks, e.g., fill-in-the-middle and spans in-filling tasks. In this example, for each input sequence selected from unlabeled discrete training data, the system can apply binary masks to discrete tokens included in the input sequence. The binary masks include one or more first masks defining conditioning tokens in the sequence and one or more second masks defining infilling tokens in the sequence. The system can then train the diffusion model on the masked input sequence to generate an estimate of the infilling tokens included in the masked input sequence, i.e., to generate an estimate of the original discrete tokens included in the input sequence which are masked by the second masks.

As another example, the system can initialize the de-embedding matrix R to the transpose of the embedding matrix E prior to the training. The values of the embedding matrix E may be pre-trained. In a pre-training stage, a BERT model of fixed size (for example 150m parameters) and feature dimension 896 may be trained in order to generate the word embeddings.

As yet another example, to stabilize the training and to avoid the drops in unigram entropy, the system can specifically train the de-embedding matrix R, and in the meanwhile keep the embedding matrix E fixed during the training. Thus, while the de-embedding matrix R is learned during training of the diffusion model, the embedding matrix E is not learned during the training.

In this example, being “learned” means that one or more values included as entries of the de-embedding matrix R will be adjusted during the training of the diffusion model. In contrast, being “not learned” means that the pre-defined values included as entries of the embedding matrix E, which have been determined prior to the training of the diffusion model (e.g., determined as a result of the training of another neural network together with which the embedding matrix E was learned), will remain fixed throughout the training of the diffusion model.

As has been described previously, in one example where self-conditioning is used, the x₀ estimate is progressively refined by passing the estimate obtained at the previous sampling step as input to the diffusion model. To approximate the inference behavior at train time while remaining computationally efficient, a first estimate is computed with the self-conditioning set to zero:

\tilde{x}₀=\dot{x}₀(xₜ,0,t,θ).

A second forward pass is then performed using a stop gradient on \tilde{x}₀ to obtain:

\dot{x}₀(xₜ,\check{x}₀,t,θ)

The diffusion model is then optimized using the output from the two forward passes in order to estimate x₀ accurately with and without self-conditioning.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for generating an output sequence of discrete tokens using a diffusion model, the method comprising:
generating, by using the diffusion model, a final latent representation of the sequence of discrete tokens that includes a determined value for each of a plurality of latent variables, wherein generating the final latent representation comprises, at each of multiple reverse diffusion time steps:
processing a diffusion model input comprising an intermediate latent representation of the sequence of discrete tokens for the reverse diffusion time step to generate an estimate of the sequence of discrete tokens as of the reverse diffusion time step;
using the estimate to define a distribution over a continuous space of possible values for each of the plurality of latent variables; and
generating an updated intermediate latent representation of the sequence of discrete tokens for the reverse diffusion time step through sampling from the distributions;
applying a de-embedding matrix having learned values to the final latent representation of the output sequence of discrete tokens to generate a de-embedded final latent representation that includes, for each of the plurality of latent variables, a respective numeric score for each discrete token in a vocabulary of multiple discrete tokens;
selecting, for each of the plurality of latent variables, a discrete token from among the multiple discrete tokens in the vocabulary that has a highest numeric score; and
generating the output sequence of discrete tokens that includes the selected discrete tokens.

2. The method of claim 1, wherein the discrete tokens comprise text, symbols, or signals.

3. The method of claim 1, wherein the diffusion model input further comprises an estimate of the sequence of discrete tokens generated as of a previous reverse diffusion time step.

4. The method of claim 1, wherein generating the output sequence of discrete tokens using the diffusion model comprises generating unconditional discrete tokens.

5. The method of claim 1, wherein generating the output sequence of discrete tokens using the diffusion model comprises generating discrete tokens conditioned on an input sequence of discrete tokens, and wherein the method comprises:
receiving the input sequence of discrete tokens;
converting each discrete token in the input sequence into a one-hot vector; and
applying an embedding matrix having pre-trained values to each one-hot vector to embed the one-hot vector into a continuous vector.

6. The method of claim 5, wherein the output sequence of discrete tokens also includes the input sequence of discrete tokens received by the diffusion model.

7. The method of claim 5, further comprising:
applying a linear projection to the continuous vector to generate a projected continuous vector; and
processing the projected continuous vector using the diffusion model.

8. The method of claim 5, wherein generating the discrete tokens conditioned on the input sequence of discrete tokens comprises using a classifier-free guidance technique.

9. The method of claim 1, wherein the de-embedding matrix has been learned during training of the diffusion model while the embedding matrix is fixed during the training of the diffusion model.

10. The method of claim 1, further comprising training the diffusion model on unlabeled discrete token data comprising discrete token inputs to minimize a mean-squared error between each discrete token input and an estimate of the discrete token input generated by the diffusion model as of a sampled reverse diffusion time step.

11. The method of claim 10, wherein the training also minimizes a cross-entropy loss evaluated with respect to the final latent representation of the sequence of discrete tokens generated by the diffusion model from the discrete token input.

12. The method of claim 10, wherein the training comprises:
applying binary masks to a sequence of discrete token inputs, the binary masks comprising one or more first masks defining conditioning tokens in the sequence and one or more second masks defining infilling tokens in the sequence; and
training the diffusion model on the masked sequence of discrete token inputs to generate an estimate of the sequence of discrete token inputs that includes the infilling tokens in the sequence.

13. The method of claim 10, wherein the training comprises learning values of the de-embedding matrix while keeping the pre-trained values of the embedding matrix fixed.

14. A system comprising one or more computers and one or more storage devices storing instructions that are operable, when executed by the one or more computers, to cause the one or more computers to perform operations for generating an output sequence of discrete tokens using a diffusion model, wherein the operations comprise:
generating, by using the diffusion model, a final latent representation of the sequence of discrete tokens that includes a determined value for each of a plurality of latent variables, wherein generating the final latent representation comprises, at each of multiple reverse diffusion time steps:
processing a diffusion model input comprising an intermediate latent representation of the sequence of discrete tokens for the reverse diffusion time step to generate an estimate of the sequence of discrete tokens as of the reverse diffusion time step;
using the estimate to define a distribution over a continuous space of possible values for each of the plurality of latent variables; and
generating an updated intermediate latent representation of the sequence of discrete tokens for the reverse diffusion time step through sampling from the distributions;
applying a de-embedding matrix having learned values to the final latent representation of the output sequence of discrete tokens to generate a de-embedded final latent representation that includes, for each of the plurality of latent variables, a respective numeric score for each discrete token in a vocabulary of multiple discrete tokens;
selecting, for each of the plurality of latent variables, a discrete token from among the multiple discrete tokens in the vocabulary that has a highest numeric score; and
generating the output sequence of discrete tokens that includes the selected discrete tokens.

15. The system of claim 14, wherein the discrete tokens comprise text, symbols, or signals.

16. The system of claim 14, wherein the diffusion model input further comprises an estimate of the sequence of discrete tokens generated as of a previous reverse diffusion time step.

17. The system of claim 14, wherein generating the output sequence of discrete tokens using the diffusion model comprises generating unconditional discrete tokens.

18. The system of claim 14, wherein generating the output sequence of discrete tokens using the diffusion model comprises generating discrete tokens conditioned on an input sequence of discrete tokens, and wherein the method comprises:
receiving the input sequence of discrete tokens;
converting each discrete token in the input sequence into a one-hot vector; and
applying an embedding matrix having pre-trained values to each one-hot vector to embed the one-hot vector into a continuous vector.

19. The system of claim 14, wherein the de-embedding matrix has been learned during training of the diffusion model while the embedding matrix is fixed during the training of the diffusion model.

20. A computer storage medium encoded with instructions that, when executed by one or more computers, cause the one or more computers to perform operations for generating an output sequence of discrete tokens using a diffusion model, wherein the operations comprise:
generating, by using the diffusion model, a final latent representation of the sequence of discrete tokens that includes a determined value for each of a plurality of latent variables, wherein generating the final latent representation comprises, at each of multiple reverse diffusion time steps:
processing a diffusion model input comprising an intermediate latent representation of the sequence of discrete tokens for the reverse diffusion time step to generate an estimate of the sequence of discrete tokens as of the reverse diffusion time step;
using the estimate to define a distribution over a continuous space of possible values for each of the plurality of latent variables; and
generating an updated intermediate latent representation of the sequence of discrete tokens for the reverse diffusion time step through sampling from the distributions;
applying a de-embedding matrix having learned values to the final latent representation of the output sequence of discrete tokens to generate a de-embedded final latent representation that includes, for each of the plurality of latent variables, a respective numeric score for each discrete token in a vocabulary of multiple discrete tokens;
selecting, for each of the plurality of latent variables, a discrete token from among the multiple discrete tokens in the vocabulary that has a highest numeric score; and
generating the output sequence of discrete tokens that includes the selected discrete tokens.
